(19) United States
(12) Patent Application Publication
(10) Pub. No.: US 2011/0264495 A1
(43) Pub. Date: Oct. 27, 2011

(54) AGGREGATION OF TAGGED MEDIA ITEM INFORMATION

(75) Inventors: Michael B. HAILEY, Campbell, CA (US); Peter T. LANGENFELD, Belmont, CA (US)

(73) Assignee: APPLE INC., Cupertino, CA (US)

(21) Appl. No.: 12/765,613

(22) Filed: Apr. 22, 2010

(51) Int. Cl. G06F 17/30; G06F 15/16; G06Q 30/00; G06F 3/01

(52) U.S. Cl. 705/14.16; 707/736; 715/716; 709/227; 709/248; 707/E17.044; 705/26.1

(57) ABSTRACT

In one embodiment, media items can be identified as being of interest (i.e., “tagged”) as they are being played, and this information can then be sent to a tag aggregator, which aggregates tags from multiple types of devices. The tag aggregator can be located on the same device as a tagging application on which the media items are tagged, or alternatively it can be located on a different device.

### TECHNICAL FIELD

The embodiments described herein relate generally to the field of playing media items on electronic devices. More particularly, the embodiments described herein relate to aggregation of information relating to media items that have been tagged on electronic devices.

### BACKGROUND

The playing of media items, such as songs, videos, audio books, etc. on various electronic devices has become commonplace. Now more than ever users have the opportunity to play these media items on many different devices. It is not unusual for an average user to own and operate multiple devices, such as portable media players, cell phones, laptop computers, and desktop computers. This is in addition to the multitude of electronic devices used to play media items for years, such as televisions, home stereos, and car radios.

Unfortunately, with the plethora of different devices and different mechanisms available for playing media items, it can be difficult to track the media items which the user has identified as being items of interest. This can quickly become overwhelming as the user adds more and more devices and more and more applications into the mix.

Therefore, what is desired is a system, method, and apparatus for providing a tagging solution that allows for a more user-friendly environment when dealing with multiple media devices and/or multiple media-related applications.

### SUMMARY OF THE DESCRIBED EMBODIMENTS

In one embodiment, media items can be identified as being of interest (i.e., “tagged”) as they are being played, and this information can then be sent to a tag aggregator, which aggregates tags from multiple types of devices. The tag aggregator can be located on the same device as a tagging application on which the media items are tagged, or alternatively it can be located on a different device.

In another embodiment, multiple tag aggregators can be used simultaneously to aid in the updating of information regarding media items of interest across a greater range of devices. This is especially useful in cases where a particular tagging application may not be able to directly interface with a particular tag aggregator.

In another embodiment, the tag information can flow in a different direction. For example, rather than merely traveling from tagging application to tag aggregator, the tag aggregator may transmit the information to media sources. In this way, for example, a partner media source who has embedded particular metadata in transmitted media items, or who has configured a proprietary tagging application to be compatible with the tag aggregator, can receive tag information originally tagged by different tagging applications.

In some cases, a tag aggregator and a media source can enter into a mutually beneficial relationship (referred to as partnering) that can provide benefits for both the tag aggregator and media source. For example, in some cases, a media source can be compensated for embedding or otherwise associating metadata with particular media items or for configuring an otherwise proprietary tagging application to be compatible with the tag aggregator. The compensation can take many forms, such as financial incentives along the lines of a bonus that can be received when, for example, a media item (or items) tagged using the proprietary tagging applications has been purchased.

Other apparatuses, methods, features and advantages of the described embodiments will be or will become apparent to one with skill in the art upon examination of the following figures and detailed description. It is intended that all such additional apparatuses, methods, features and advantages be included within this description be within the scope of and protected by the accompanying claims.

### BRIEF DESCRIPTION OF THE DRAWINGS

The described embodiments and the advantages thereof may best be understood by reference to the following description taken in conjunction with the accompanying drawings.

FIG. 1 is a diagram illustrating a representative system of devices in accordance with one embodiment.

FIG. 2 is a diagram illustrating a representative system of multiple tag aggregators in accordance with another embodiment.

FIG. 3 is a diagram illustrating a system including a media management server in accordance with one embodiment.

FIG. 4 is a diagram illustrating an example of a client application acting as a tag aggregator in accordance with one embodiment.

FIG. 5 is a block diagram illustrating various components that may be contained in a portable media device in accordance with one embodiment.

FIG. 6 is a block diagram illustrating a media management server in accordance with one embodiment.

FIG. 7 is a flow diagram illustrating a method in accordance with one embodiment.

FIG. 8 is a flow diagram illustrating an alternative method in accordance with another embodiment.

FIG. 9 is a flow diagram illustrating a method in accordance with another embodiment.

### DETAILED DESCRIPTION OF EXAMPLE EMBODIMENTS

In the following detailed description, numerous specific details are set forth to provide a thorough understanding of the concepts underlying the described embodiments. It will be apparent, however, to one skilled in the art that the described embodiments may be practiced without some or all of these specific details. In other instances, well known process steps have not been described in detail in order to avoid unnecessarily obscuring the underlying concepts.

Broadcasts of digital content for personal use now includes Hybrid Digital (HD) radio, satellite radio, streaming audio/video as well as streaming audio services such as Pandora and Last.fm. In addition to broadcasts of digital content, direct transmission of digital content to handheld devices (via cellular networks or wireless computer networks, for example) has also become popular. However, this explosion in the available digital content and number of digital content sources can overwhelm a digital content consumer. When the digital content consumer is consuming digital content (i.e., listening to an MP3 file or viewing digital video), the digital content consumer may want a particular item of digital content to be marked (also referred to as “tagged”) for subsequent processing. For example, when the digital content consumer is listening to a particular media item (such as a song or musical composition encoded as an MP3 file) and decides that the media item is interesting (for whatever reason) then it would be an advantage for the digital content consumer to be able to identify the MP3 file corresponding to the media item for subsequent processing.

In the context of the described embodiments, any number of tags from different types of sources can be aggregated at a single location for subsequent processing. For example, a digital content consumer can be listening to a music item in the form of an encoded MP3 file from a streaming music source. The digital content consumer can at any time cause the music item to be tagged for subsequent processing by, for example, creating a tag containing some of the metadata from the MP3 file. The tag can then be forwarded to a tag aggregator described in more detail below. The digital content consumer then has the option of tagging another music item from the same digital content provider or switch to another digital content provider entirely and tag digital content provided by that digital content provider.

Once the tags are received at the tag aggregator, the digital content consumer can at any time initiate whatever subsequent processing is deemed appropriate. For example, when the digital content consumer decides to purchase the tagged music item, an online store (such as that provided by the iTunes store managed by Apple Inc. of Cupertino, Calif.) can be accessed to complete the transaction. It should be noted that the subsequent processing can result in subsidiary actions. For example, an agreement between an online store and a digital content provider can provide for incentives to the original media source for digital content purchased from the online store. Such incentives can include financial remuneration, bonuses, and so forth.

The tag aggregator can be located in various locations, depending upon implementation. In one embodiment, the tag aggregator can be located in a software application running on a desktop computer. In another embodiment, the tag aggregator can be located in a portable device, such as a laptop computer, a portable media device, or a cellular phone. In another embodiment, the tag aggregator can be located on a server.

In one embodiment, communication between a tagging application and a tag aggregator can be accomplished via a general synchronization program that is run when a device containing the tagging application is connected to a device containing the tag aggregator. A tagging application is an application on which the media item is tagged, such as a media application like a streaming audio application or HD radio receiver. During this general synchronization, the tagging application can also transmit tag information from the tagging application to the tag aggregator while both applications are operating. This transmission may be unidirectional, i.e., the tagging application may send the tag information to the tag aggregator, but the tag aggregator may not transmit other tag information to the tagging application. In another embodiment, however, tag information may be transmitted in both directions.

In another embodiment, the communication can be established without an active synchronization process, such as, for example, by the tagging application saving the tag information in a predesignated location, and then subsequently retrieving the tag information from that predesignated location. In another embodiment, the communication can be established through the use of an Application Programming Interface (API).

In another embodiment, tag aggregators can be located in multiple devices in a network, and the tag aggregators can be configured to operate together to track tag information. As an example, a tag aggregator can be located in a client application operating on a home computer, as well as located at a media management server corresponding to the client application. The tag aggregator at the home computer can be used to aggregate tag information from tagging applications running on the home computer as well as from tagging applications running on devices that synchronize with the home computer, such as portable media devices. The tag aggregator at the media management server can then aggregate tag information from the client application running on the home computer, as well as from client applications running on different computers, and furthermore directly from other devices that have not interfaced with a client application, such as a cellular phone. Media playlists at the various tag aggregators can be coordinated with each other to create a single list of tagged media items, wherein the same single list can be accessed in multiple locations. In such a manner, a user can, for example, access the same list from any device and any application running on the device.

In another embodiment, a tag aggregator can be controlled by a third party. For example, the original source of the media item, such as a streaming audio provider, can aggregate identifications of media items of interest that were “tagged” using a corresponding streaming audio application. These identifications can then be passed to a tag aggregator associated with a particular user. For example, the third party tag aggregator could pass this information to a media management server, which maintains its own tag aggregator and an account associated with the user.

In one embodiment, tag information can be passed from a tagging application to a tag aggregator (or one tag aggregator to another tag aggregator) upon general synchronization of a device containing the tagging application (or tag aggregator) with a device containing the tag aggregator. This synchronization can occur either via a wired connection, or may alternatively occur via wireless communication. The passing of tag information can also occur automatically and periodically. For example, wireless synchronization could occur once a minute, and tag information could be passed during this synchronization. Alternatively, the tag information passing may occur only upon specific events, such as the physical connection of one device to another, or upon a specific request for tag information. In another alternative, tag information can be passed between tagging applications and tag aggregators can occur in real-time, e.g., immediately upon receiving a tagging action from a user.

The above describes transferring tag information in one direction, namely from the tagging application to the tag aggregator. In another embodiment, this information may flow in multiple directions. Namely, aggregated tag information can be passed back to a media source (either directly or via the tagging application). This may be most useful in cases where the tagging application interfaces with a third party media source that could benefit from knowing the tag information.

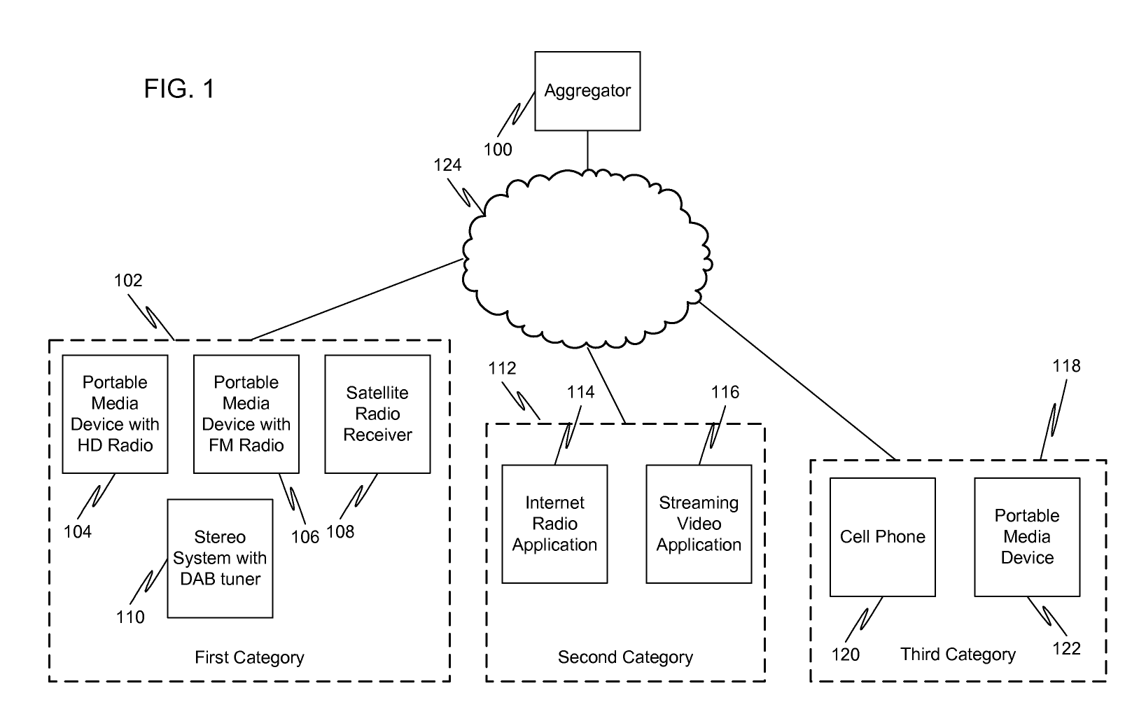

FIG. 1 is a diagram illustrating a representative system of devices in accordance with one embodiment. Here, tag aggregator 100 can receive tag information from multiple devices/applications. For simplicity, the different devices/applications can be grouped into three categories. First category 102 includes devices/applications that receive direct broadcasts from one or more media sources. This includes applications/devices having integrated receivers, such as portable media device with integrated Hybrid Digital radio receiver 104, portable media device with integrated FM radio receiver 106, stand-alone satellite radio receiver 108, and stereo system with integrated DAB digital radio receiver 110.

Second category 112 includes devices/applications that receive streaming media items via an Internet or other networking stream. This could include, for example, software application 114 that receives an Internet radio broadcast. This could also include streaming video application 116. It should be noted that these applications can be located on the same device as tag aggregator 100, or they can be located on separate devices.

Third category 118 includes devices/applications that run as stand-alone applications on portable media devices and phones. This includes, for example, a music identification application, such as Shazam, but generally can include any stand-alone application receiving content data at a portable media device over a wireless network. These applications may be configured to interface with tag aggregator 100 via an API.

It should be noted that cloud 124 is depicted between tag aggregator 100 and the applications in order to indicate that the exact communications medium can vary based on implementation and the type of tagging application. This cloud is intended to encompass all possible methods of transferring tag information from a tagging application to a tag aggregator including, but not limited to, direct cable connection, wireless communication such as Wi-Fi, Bluetooth, and cell phone protocols, direct communication when the tagging application and the tag aggregator are both running simultaneously on the same device, or passive communication such as the tagging application saving the information in a predesignated location for the tag aggregator to retrieve at a later time.

For purposes of this description, each of these media devices/applications is a tagging application, as tagging occurs on the devices and/or using the application. Of course, the tagging applications depicted in this figure are merely examples of devices and applications that fit into each of the three categories. This figure is not intended to be limiting as to the type or number of devices/applications utilized. It should also be noted that these categories may contain some overlap. For example, it is possible that a streaming audio application on a portable media device may be configured to receive media items directly via an Internet stream when at a user's home (and able to connect to the user's broadband connection), and also configured to receive media items via a cell phone network when away from home.

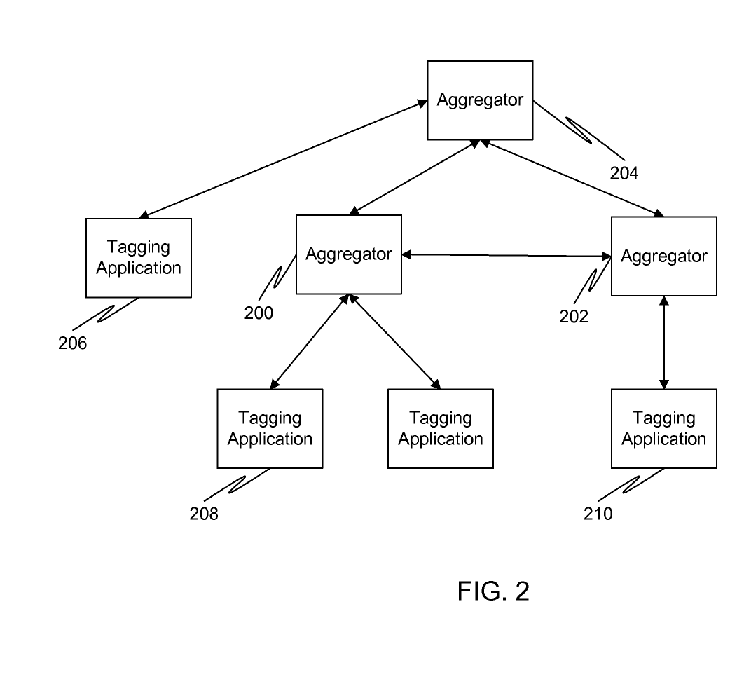

FIG. 2 is a diagram illustrating a representative system of multiple tag aggregators in accordance with another embodiment. Each tag aggregator 200, 202, 204 directly services any number of different devices/applications. Tag aggregators 200, 202, 204 can be configured in a hierarchical fashion, as pictured, where one tag aggregator 204 receives tag information from other tag aggregators 200, 202. However, embodiments are possible where multiple tag aggregators are contained in a system without using a hierarchical organization (e.g., configured serially). Tag aggregator 204 can also receive tag information directly from tagging application 206.

The tag aggregators may be located on the same or different devices. The hierarchical organization of the tag aggregators can be tailored to the organization scheme of a network of devices. For example, a user may have a desktop computer and a laptop computer, as well as an account at a media management server. In such a case, the user may have client applications (e.g., iTunes™ applications) for the media management server (e.g., iTunes™ store) running on both the desktop computer and the laptop computer. The user may also have a number of different tagging applications, some running on either the desktop or laptop computer, and some running on other devices (e.g., portable media devices, cell phones, etc.) that can interface with the desktop or laptop computer (but possibly not both). In such a case, it may be beneficial to locate tag aggregator 200 on the home computer, tag aggregator 202 on the laptop computer, and tag aggregator 204 on the media management server. With such a design, tag information from applications running on the home computer or on devices that interface with the home computer can be aggregated by tag aggregator 200. Tag information from applications running on the laptop computer or on devices that interface with the laptop computer can be aggregated by tag aggregator 202. Tag aggregator 204 can then aggregate the information from tag aggregator 200 and tag aggregator 202, as well as tag information received directly at the media management server from tagging applications, such as from a tagging application running on a cell phone that connects directly to the media management server.

This tag information aggregated by tag aggregator 204 can then be coordinated with tag aggregators 200, 202. In this manner, for example, tag aggregator 200 may eventually contain the same list of tagged media items as tag aggregator 202, even though a user tagged one media item on a tagging application 208 that directly connects to tag aggregator 200, and tagged another media item on a tagging application 210 that does not directly connect to tag aggregator 200. Thus, the user can access the list at any of tag aggregators 200, 202, and 204, and view tag information from all devices, regardless of the device or application on which the tagging was performed. This coordination process can include what is commonly referred to as “data synchronization,” Data synchronization is the process of establishing consistency among data from a source to a target data storage and vice versa and the continuous harmonization of the data over time. In this way, data synchronization provides all applications access to the same data. This data synchronization should not be confused with the general synchronization between devices described earlier, which may or may not include coordinating lists of tagged media items.

In another embodiment, tag information can flow not just to tag aggregators, but also from the tag aggregators to other locations. Namely, tag information can be passed back to the media source (either directly or via a client application or tagging application). This may be most useful in cases where the tagging application interfaces with a third party media source that could benefit from knowing the tag information.

For example, a streaming audio application may be installed on a handheld device or accessed through a web browser. The streaming audio application receives input as to a song, artist, or genre of interest, and a server associated with the streaming audio application then tailors music to be streamed to the application based upon the input. The streaming audio source relies on an extensive database that tracks similarity of music to other pieces of music, so that the streamed music is similar to the song, artist, or genre of interest as input. A list of other songs tagged at other applications may be useful information to the streaming audio source, so that it can better tailor its database to users' likes and/or dislikes. Of course, this is merely one example, and one of ordinary skill in the art will recognize that there are many possible uses for such information.

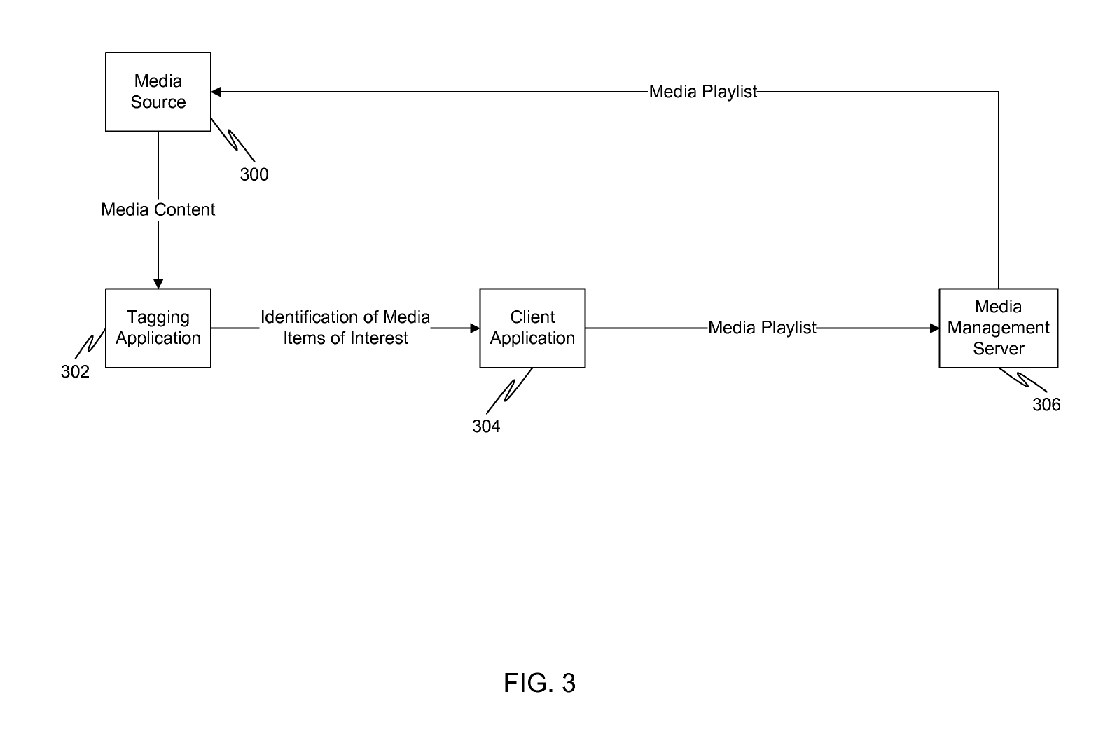

This is depicted visually in FIG. 3, which is a diagram illustrating a system in accordance with one embodiment. Here, content is transmitted from media source 300 to tagging application 302, where a particular item of content is identified (e.g., “tagged”). The identification information is shown being transferred from tagging application 302 to the client application 304 (e.g., iTunes™ application), where it is added to its media playlist. The media item playlist can then be coordinated with a media item playlist at media management server (e.g., iTunes™ store) 306. This coordination may include data synchronization, as described above. Here, however, the media playlist can also be transferred back to media source 300. It should be noted that this figure depicts the transferring as occurring directly between media management server 306 and media source 300, but embodiments are foreseen wherein the information is transferred to media source 300 through client application 304 and/or tagging application 302.

It should also be noted that FIG. 3 depicts an embodiment where the tagging application resides on a separate device from the client application. As stated above, embodiments are foreseen where tagging application resides on the same device as the client application, or even where the client application and tagging application are part of the same application. Such embodiments also apply to the idea of sending tagged media item information back to the media source.

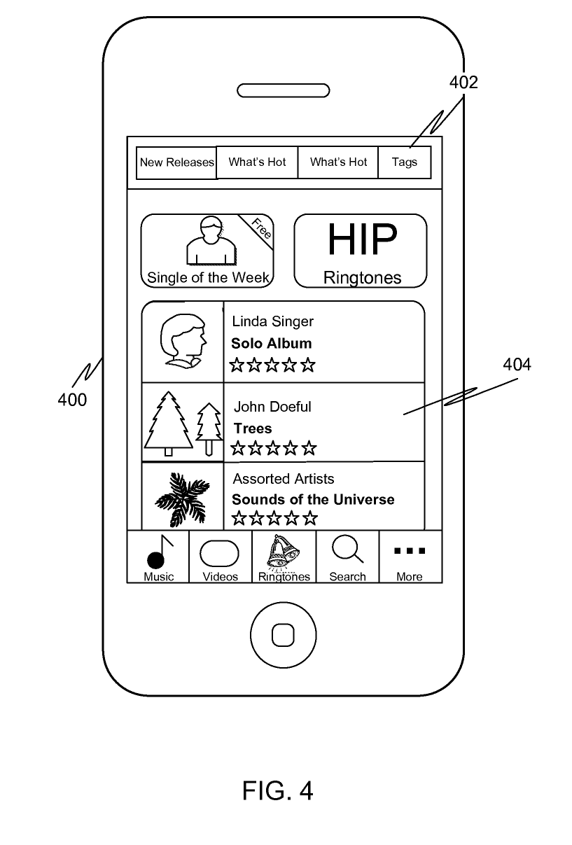

FIG. 4 is a diagram illustrating an example of a client application (e.g., an iTunes™ application) acting as a tag aggregator in accordance with one embodiment. Here, the client application is running on a portable media device (e.g., an iPhone™). Here, a user interface can provide a separate “tags” tab 402. When the “tags” tab is selected, the user interface can switch from displaying a list of song albums 404 to displaying a list of tag information that has been aggregated at the client application.

It should be noted that, for purposes of this description, a tagged media item is any media item that has been identified in some way as being an item of interest. Without being limited to particular mechanisms for tagging, examples of mechanisms to tag media items include graphical buttons or menu selections in graphical user interfaces (GUIs), physical buttons on hardware devices utilized to play the media items (such as a dedicated “tag” button on a car radio), and keyboard or other general input devices. In one embodiment, an integrated chipset may be provided in various electronic components to enable the tagging function. For example, a car radio can be manufactured to include an integrated tagging chipset.

In another example, various applications may be made available to a portable media device or cellular phone that includes tagging functionality. In one specific example, applications created for use on the iPhone™ and distributed through the AppStore™ may include added functionality designed to implement tagging. In some cases, application manufacturers may be provided with design specifications to conform their applications to a tagging standard. This may include providing information as to where on the device the application should store the tagged media item information and how it should communicate this information to a separate client application.

Additionally, the term “media item” is not intended to be limiting. Examples of media items include songs, and/or other audio files videos, text documents, web pages, emails, pictures, etc. The mechanisms by which these media items are played can also vary. The embodiments described herein may be described in terms that are related to the tagging of media items as they are being received and played. Such embodiments may include instances where the corresponding media item file is not actually being stored on the device that is playing the media item. Examples of such embodiments include radios or home stereo devices. The embodiments may also be applied to devices that store portions, but not all, of the media items being played, such as in the case of streaming Internet radio, where a portion of the media item may be placed in a buffer to reduce errors that may be caused by latency problems during the streaming. Furthermore, the embodiment may also be applied to devices that store the entire media item, such as portable media players used to download media items from a home computer during general synchronization.

Turning now to the process of tagging media items, when this occurs, a snapshot of some or all of the metadata associated with the media item can be taken and utilized. This information can be used to compile a list of tagged media items as described above. Neither the list nor the information need to store a portion of the actual media item itself (although embodiments where such storage occurs are possible).

In one embodiment, all the available metadata for a particular media item is stored as part of the tag for the media item. For example, one common way to store audio files in a computer or portable media device uses the Moving Picture Experts Group-I Audio Layer 3 (MP3) protocol. This protocol includes metadata information stored in an ID3 container, where title, artist, album, track number, and other information about the media item to be stored in the file itself. In one embodiment, this ID3 container is simply copied and used as the tag for the media item. In another embodiment, only some of the fields in the ID3 container are copied and used as the tag.

The metadata may be embedded at multiple places depending upon the type of the media item and the mechanism of transmission. Broadcasters may partner with the media management server to embed metadata designed for use with the media management server, in exchange for remuneration if items are ultimately purchased from the media management server. This will be described in more detail later in this document. The embedded metadata, therefore, may contain information that may be useful to the media management server in making this remuneration, in addition to the mere identification of the media item itself. This metadata may, in certain circumstances, also be uniquely readable by the company operating the media management server, thus preventing other companies from utilizing the embedded information without permission.

For all types of media items, additional metadata may be tracked, such as an identification of the source of where it was transmitted from, such as the call sign and dominant market area (DMA) of a radio or television station, identification of a radio or television network with which the transmitter is affiliated, or the like.

Metadata can also include a timestamp indicating the data and time that the media item was tagged. In some embodiments, this timestamp may be utilized to aid in the identification of the media item. For example, if the metadata also includes information about the media source (such as a particular radio station), the timestamp can be used to access a database indicating what song was playing on that particular radio station at the time the song was tagged.

In that sense, the amount of metadata stored in a tag may vary, even in a single embodiment, based upon the type of the media item and the source of the media item. Media items tagged from a traditional radio station, for example, may require less metadata for identification purposes than media items tagged from an Internet stream.

It should be noted it is not necessary for the metadata stored in the tag to be retrieved from the media item itself. Embodiments are foreseen wherein the system can generate new metadata at the time the item is tagged, and this new metadata can be used as the identifying tag.

In one embodiment, in addition to or instead of extracting metadata from the transmission itself, a portion of the transmitted content can be captured for later use in identifying the transmission. The captured portion can be, for example, any portion usable as a “fingerprint” to identify the broadcast from which the portion was captured. For example, a second or two of the content may be captured. This may be sufficient to be used to identify the media item by accessing a database of stored content information relating to a plurality of media items.

In one embodiment, the metadata captured may include information about the device itself on which the media item was tagged. For example, if the media item was tagged on a particular iPhone™, identification information regarding that particular iPhone™ can be recorded and saved in the metadata. While it isn't strictly necessary for such information to be used later in an aggregated playlist, there may be embodiments where such information could be handy, such as if the aggregated playlist was preferred to be organized by device rather than alphabetically or by some other standard.

While it is not necessary for any particular information to be used in the tag, the more unique the information used, the less likely it is that two media items may get confused with one another. It may also be helpful for the information in the tag to, at the very least, be able to uniquely identify the media item to the media management server. The media management server may have access to a database of available media items to purchase, and may take steps to correlate the tagged media items with media items in that database. As such, any information that would be helpful to the media management server is making that connection is helpful to have stored in the tag. The media management server, however, may take additional steps to attempt to deduce the identity of the media item should the tag itself not be sufficient. For example, if the identification information contained an album title but misidentified the song title, the media management server could deduce the title of the song by comparing the length of the song to information it the database regarding the length of the songs contained in that particular album.

In another embodiment, location information may be stored in the tag. This location may be relative or absolute. For example, the tag can include information about whether the media item was tagged at home or at work. This information can be utilized later, either by the user in deciding whether or not to purchase items in the tagged media item list (e.g., the user may be more likely to purchase items tagged while working if the user spends a lot of time at work), or by other applications (e.g., if an application is to suggest songs to play and knows the user is at work, the application will be more likely to suggest songs from the tagged media item list that were tagged when the user was at work).

As described above, the device on which the media item is originally “tagged” may be one of many different types of devices. In one embodiment, the device is a portable media device. A portable media device generally refers to a portable electronic device that has the capability of storing and playing media items, including but not limited to audio files, video files, still images, and the like. The portable media device can also be connected to an accessory that includes a receiver capable of receiving transmissions from other sources that include media items delivered as they are being played. Examples of such non-computing accessories include radio or satellite tuners, which are designed to receive broadcasts from third party sources, such as FM, HD, or satellite broadcasters. The accessory can be a separate device from the portable media device or, alternatively, can be integrated into the portable media device itself.

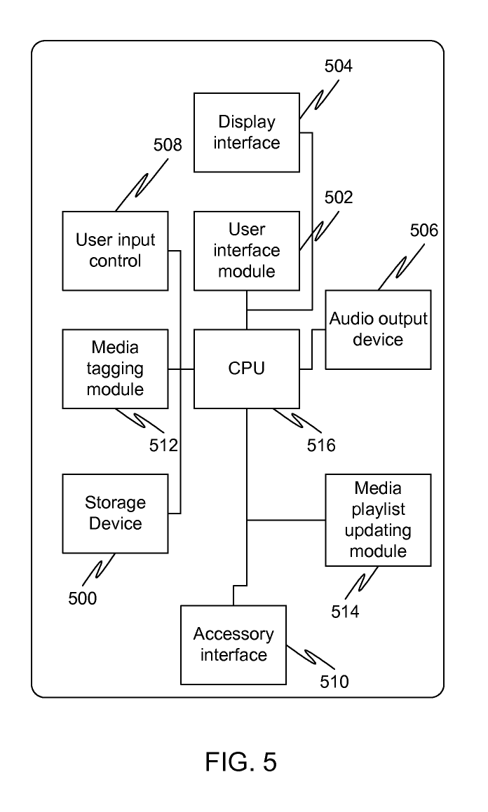

FIG. 5 is a block diagram illustrating various components that may be contained in a portable media device in accordance with one embodiment. This includes storage device 500, which can be used to store media items as well as store tagged media item information. The portable media device may also contain user interface module 502, display interface 504, audio output device 506 (such as a speaker or headphone jack), and user input control 508, and accessory interface 510. User input control 508 can include, for example, one or more buttons, touch pads, touch screens, scroll wheels, click wheels, or any other devices capable of generating communication signals corresponding to actions taken by a user. In the case of a touch screen, User input control 508 may be integrated with display interface 504, since the display acts as both an input and an output device.

User interface module 502 can include any combination of circuitry and/or software that enables a user to control operation of the portable media device. User interface module 502 also can receive data from storage device 500 and provide corresponding output to the user via display interface 504 or audio output device 506.

In one embodiment, user interface module 502 can include a control that can be operated via user input control 508 to tag media items as they are being played. For example, user interface module 502 can cause a “tag” button to appear on a user interface displayed on the display, which can be pressed at any time while playing a media item, to indicate that a currently playing media item should be tagged.

Media tagging module 512 may be used to save metadata relating to a media item playing at the time a tagging action is received by user interface module 502.

Storage device 500 can be used to store media items as well as the metadata identifying the media items that have been tagged. Storage device 500 can include, for example, magnetic or optical disk, flash memory, or any other non-volatile memory. Additional embodiments are also possible where volatile memory (e.g., RAM) is utilized, however such embodiments would be more useful in cases where the media items themselves are stored somewhere else and storage device 500 is merely used to temporarily store tagged media item information until it can be coordinated with a client application. It should also be noted that embodiments are possible where that the tag information is stored in a memory dedicated solely for that purpose (e.g., a “tag” store).

In whatever form the tag information is stored, it can eventually be retrieved by a tag aggregator. If the tag aggregator resides on a different device than the tagging application, this may involve using general synchronization. The general synchronization may utilize a direct wired connection, or may be performed wireless sly through some sort of wireless communications protocol such as cell phone or Wi-Fi protocols. The passing of tag information, whether it is during general synchronization or at another time, may be accomplished using media playlist updating module 514.

Processor 516 may be included to coordinate the various elements of the portable media device and to operate any steps necessary to perform the actions described in the various embodiments herein that are not performed by other components.

The tag aggregator can manage a media items playlist, which can be stored in memory. The tag aggregator can use tag information from the tagging application and add it to the tagged media items playlist. It should be noted that the tag aggregator's retrieving of tag information identifying can be performed in a number of different ways.

In one embodiment, as media items are being tagged, the tags are stored in a predesignated location on the device in which the media items are being played. This predesignated location can be known to either the tag aggregator or an intermediary application that will interface with the client application (such as a synchronization application designed to interface with an iTunes™ application). This predesignated location may or may not be shared by multiple applications on the device. For example, the portable media device may have multiple applications from which songs can be tagged, including an HD radio tuner, a streaming Internet radio application, and an FM tuner. Each of these applications may have their own designed locations in the memory of the portable media device, or alternatively one or more of these applications can share a single location. Nevertheless, all of these locations can be known to the tag aggregator, or at the very least by the intermediary application that will interface with the tag aggregator. It should be noted that the tagging applications can also store their own set of tags in a proprietary location for their own purposes.

The tag aggregator may also have predesignated locations where tag information is stored. In cases where the tag aggregator is located on the same device as the device on which the media items are tagged, it may be easier for the tagging application itself to simply store the information in a location that the tag aggregator has predesignated for tag information, as opposed to storing the information in a location unique to the tagging application, and then later transferring the information to the tag aggregator's predesignated location (although such embodiments are not prohibited).

In one embodiment, a media management server is utilized to store a list of tagged media items on a per-user basis. An example of such a media management server is the iTunes™ system. In such a system, users create accounts and can purchase and manage various media items through the account, which can be accessed by iTunes™ applications operating on multiple devices. For example, the user may have an iTunes™ application running on a desktop computer, a laptop computer, and a cellular phone. The user is able to access his or her own iTunes™ account from each of those devices. It should be noted that the iTunes™ system is only one example of a media management server that can be utilized. One of ordinary skill in the art will recognize that other types of media management servers can be utilized as well.

It should be noted that in one embodiment, the media management server organizes the tag information by user account. In such an embodiment, a user can register with the media management server to create an account. The user can then configure one or more of the client applications under his or her control with the account information. This may include, for example, typing in a user name and password when operating the client application. Other mechanisms can then be used to associate the tagging applications with the accounts.

Multiple user situations can be handled in a variety of ways. In one embodiment, applications that are used by multiple users can default to a single user's account. In this way, if various members of a family all operate a single computer, a single user's account can be utilized to aggregate all tag information, no matter which member of the family tagged the media item. In another embodiment, the tag information may include information about the user who tagged the item, and thus even though a single account with the media management server is used to aggregated the information, the subsequent list of tagged media items can be subdivided based upon the user who did the tagging.

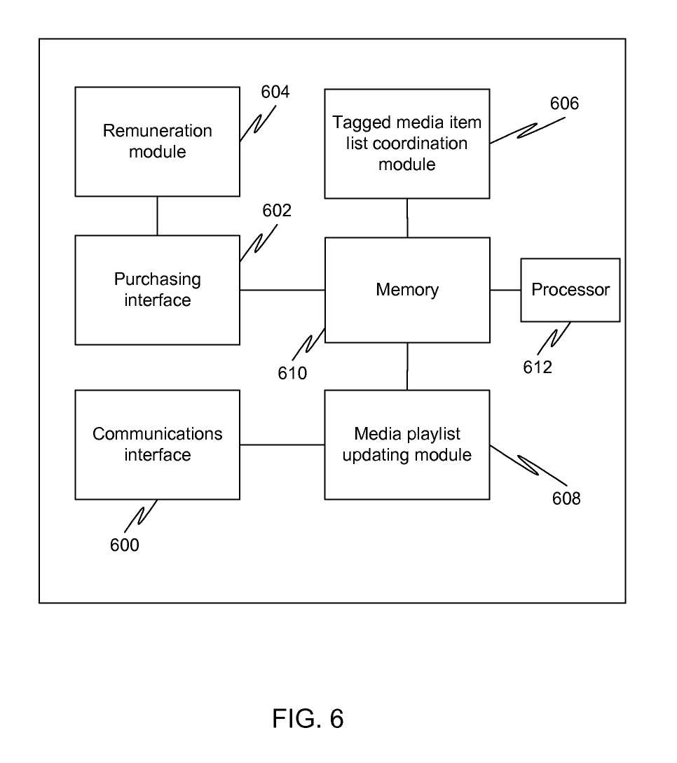

FIG. 6 is a block diagram illustrating a media management server in accordance with one embodiment. Communications interface 600 can be capable of receiving a list of tagged media items from a tag aggregator. Communications interface 600 can also be capable of receiving tag information from a tagging application. Purchasing interface 602 can be capable of receiving instructions to purchase a first tagged media item from the list of tagged media items. Purchasing interface 602 can be capable of communicating with a client application to coordinate the purchase and download of the first tagged media item. Remuneration module 604 can be capable of providing remuneration to a media source associated with the first tagged media item when the instructions to purchase the first tagged media item are received.

Tagged media item list coordination module 606 can be capable of coordinating a list of tagged media items between multiple aggregators. Media list updating module 608 can be capable of updating a list of tagged media items in a memory 610 with tag information received from a tagging application. A processor 612 can generally perform tasks related to coordinating the various modules, as well as other processing functions.

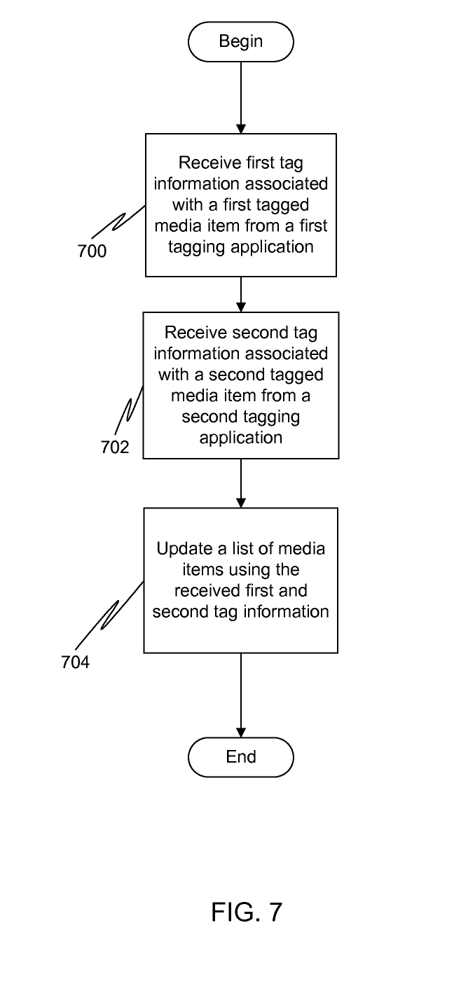

FIG. 7 is a flow diagram illustrating a method in accordance with one embodiment. This method can be performed by a tag aggregator. At step 700, first tag information associated with a first tagged media item can be received from a first tagging application. At step 702, second tag information associated with a second tagged media item can be received from a second tagging application different than the first tagging application. At step 704, a list of media items can be updated using the received first and second tag information. The act of updating the media playlist may or may not involve accessing an external database to aid in the identification of the tagged media item. In one embodiment, the types of the tagging applications can be from the three categories of applications described earlier, namely (1) applications that receive direct broadcasts from one or more media sources, (2) applications that receive streaming media items via an Internet or other networking stream, and (3) applications that run as stand-alone applications on portable media devices and phones.

This method may be performed by an application or device associated with a client application of a media management server. For example, the method may be performed on a laptop or desktop computer running an iTunes™ client application. In embodiments where the client application is operating on another device, such as portable media device, this method may be performed on that device.

The act of receiving the tag information itself may vary significantly based upon implementation. In cases, for example, where the tagging application is running on a separate device than the tag aggregator, it may be necessary for some sort of active communication to occur between the devices to transfer the information. In cases where the tagging application is running on the same device as the tag aggregator, the tagging application can simply directly transfer the information to the tag aggregator, or save the information in a predesignated location where the tag aggregator can retrieve it later (the latter is useful, for example, if the tagging application and the tag aggregator are not running at the same time).

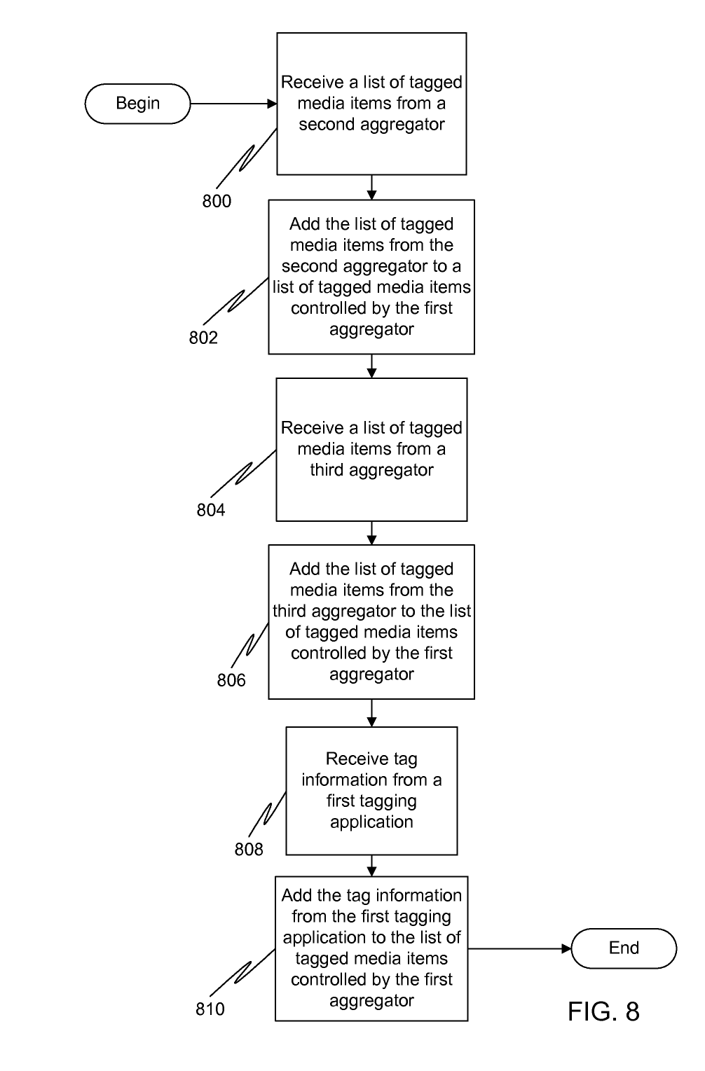

FIG. 8 is a flow diagram illustrating a method in accordance with another embodiment. This method involves operating a first tag aggregator in a system having three (or more) tag aggregators. This can be, for example, a hierarchical arrangement, with the first tag aggregator being at the top of the hierarchy (or at least at a higher level in the hierarchy than the second and third tag aggregators).

At step 800, a list of tagged media items can be received from a second tag aggregator. At step 802, the list of tagged media items from the second tag aggregator can be added to a list of tagged media items controlled by the first tag aggregator. At step 804, list of tagged media items can be received from a third tag aggregator. At step 806, the list of tagged media items from the third tag aggregator can be added to a list of tagged media items controlled by the first tag aggregator.

At step 808, tag information can be received from a first tagging application. At step 810, the tag information from the first tagging application can be added to the list of tagged media items controlled by the first tag aggregator.

The tagging application may be one of the following types: a tuner application, an Internet streaming application, or a wireless network application. The tagging application can communicate with the first tag aggregator via an API. In cases where the tagging application is created by a third party (a party other than one controlling the media management server), the third party may be compensated for making the tagging application compatible with the tag aggregator and/or embedding metadata in the media items by paying a bonus for any tagged media items are subsequently purchased.

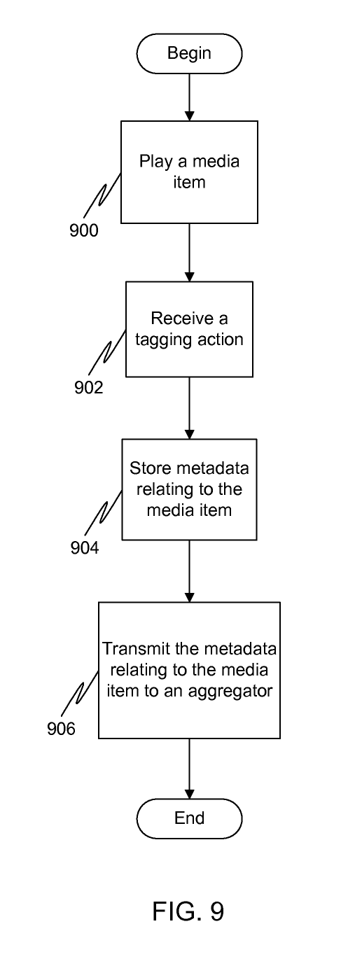

FIG. 9 is a flow diagram illustrating a method in accordance with another embodiment. This method may be performed by an application or device (such as a portable media device) associated with a tagging application. This method involves the process undertaken to “tag” a media item.

At step 900, a media item can be played. This media item may be played in a variety of different ways depending upon the type of the media item and the type of the tagging application. For a tuner application, an accessory device (such as a radio or HD tuner) can be used to aid in the playing. This accessory device may be located in the same device as the tagging application, or may be a separate device. The tagging application can be, for example, a tuner application, an Internet streaming application, a wireless network application, etc.

At step 902, a tagging action can be received. This action may be received in a number of different ways. In one embodiment, a user interface engine operating on the device can include a control that the user can operate via a user input control to tag media items as they are being played. For example, the user interface engine can cause a “tag” button to appear on a user interface displayed on the display, which the user can press at any time while listening to or watching a media item, to indicate that a currently playing media item should be tagged. In another embodiment, a physical “tag” button may be provided to the user. The tagging action may then involve the user's interaction to select one of these tag buttons.

At step 904, metadata relating to the media item can be stored. This metadata may be obtained in a number of different ways. In one embodiment, the metadata is copied from metadata embedded in the media item itself, for example, metadata stored in the ID3 tag of an MP3 file, or embedded in a hybrid digital audio stream. In another embodiment, the metadata is generated by the tagging application at the time of the tagging action. In another embodiment, the metadata may simply be a timestamp and media source (e.g., radio station) identifier. This could then be used to query a database to determine the intended tagged media.

The storing of the metadata may also take many different forms. In one embodiment, the metadata is stored in an Extensible Markup Language (XML) file in local storage. In another embodiment, the metadata is stored as a text file.

At step 906, the metadata relating to the media item can be transmitted to a tag aggregator. If the tag aggregator is located on a different device than the tagging application, this may involve transmitting the metadata via a synchronization program.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is defined as any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

The embodiments were chosen and described in order to best explain the underlying principles and concepts and practical applications, to thereby enable others skilled in the art to best utilize the various embodiments with various modifications as are suited to the particular use contemplated. It is intended that the scope of the embodiments be defined by the following claims and their equivalents.

What is claimed is:

1. A method, comprising:
receiving first tag information associated with a first tagged media item from a first tagging application;
receiving second tag information associated with a second tagged media item from a second tagging application different than the first tagging application; and
updating a list of media items using the received first and second tag information.

2. The method of claim 1, further comprising:
coordinating the list of media items with a media management server.

3. The method of claim 1, wherein the first tag information is received from the first tagging application through an application program interface (API).

4. The method of claim 1, wherein the method further comprising:
coordinating the list of media items between a first tag aggregator and a second tag aggregator.

5. The method of claim 1, further comprising:
sending the list of media items to a media source.

6. The method of claim 1, further comprising:
compensating a media source that transmitted the first tagged media item by paying a bonus if the first tagged media item is subsequently purchased.

7. A method for operating a first tag aggregator, comprising:
receiving a list of tagged media items from a second tag aggregator;
adding the list of tagged media items from the second tag aggregator to a list of tagged media items controlled by the first tag aggregator;
receiving a list of tagged media items from a third tag aggregator;
adding the list of tagged media items from the third tag aggregator to the list of tagged media items controlled by the first tag aggregator;
receiving tag information from a first tagging application; and
adding the tag information from the first tagging application to the list of tagged media items controlled by the first tag aggregator.

8. The method of claim 7, further comprising:
coordinating the list of tagged media items controlled by the first tag aggregator with both the second tag aggregator and the third tag aggregator.

9. The method of claim 7, further comprising:
receiving tag information from a second tagging application different than the first tagging application; and
adding the tag information from the second tagging application to the list of tagged media items controlled by the first tag aggregator.

10. A media management server comprising:
a communications interface capable of receiving a list of tagged media items from a tag aggregator;
a purchasing interface capable of receiving instructions to purchase a first tagged media item from the list of tagged media items; and
a remuneration module capable of providing remuneration to a media source associated with the first tagged media item when the instructions to purchase a first tagged media item are received by the purchasing interface.

11. The media management server of claim 10, wherein the purchasing interface is capable of communicating with a client application to coordinate the purchase and download of the first tagged media item.

12. The media management server of claim 10, further comprising:
a tagged media item list coordination module capable of coordinating a list of tagged media items between multiple aggregators.

13. The media management server of claim 10, wherein the communications interface is further capable of receiving tag information associated with a second tagged media item from a tagging application.

14. The media management server of claim 13, further comprising:
a memory;
a media list updating module capable of updating a list of tagged media items in the memory with the tag information associated with the second tagged media item.

15. A portable computing device, comprising:
a communication interface arranged to facilitate communication between the portable computing device and at least another electronic device;
a tagging application;
an interface arranged to receive a tagging action used to tag a media item, the media item having associated metadata;
a media tagging module that responds to the tagging action provided by the interface by saving at least some of the metadata of the tagged media item; and
a media playlist updating module configured to send the saved metadata to at least one other device by way of the communication interface, the other device including at least a first client application configured to: retrieve the metadata, use the metadata to update a first media playlist associated with the first client application, and coordinate the updated first media playlist with a media management server, wherein the media management server has a second media playlist that includes metadata from a second client application different than the first client application.

16. The portable computing device of claim 15, wherein the other device includes a tag aggregator.

17. The portable computing device of claim 15, wherein the interface arranged to receive a tagging action is a graphical user interface.

18. The portable computing device of claim 15, wherein the interface arranged to receive a tagging action is an interface to a physical button on the portable computing device.

19. An apparatus comprising:
means for establishing a connection between the apparatus and one of a plurality of different tagging applications having a tagged media item;
means for receiving metadata corresponding to the tagged media item;
means for updating a media playlist at the apparatus using the metadata; and
means for synchronizing the media playlist at the apparatus with an account at a media management server.

20. The apparatus of claim 19, wherein the means for connecting includes a physical interface accepting a cable that connects to the one of a plurality of devices, each of the devices including a tagging application.

21. The apparatus of claim 19, wherein the means for connecting includes a wireless communication interface that wirelessly connects to the one of a plurality of devices, each of the devices including a media source.

22. The apparatus of claim 21, wherein the wireless communication interface uses a cell phone communication protocol.

23. A computer readable medium for storing in non-transitory tangible form computer instructions executable by a processor for modifying an operation of a device, the computer readable medium comprising:
computer code for retrieving tag information generated by a first tagging application at a first client application on a first device
computer code for updating a media playlist associated with the first client application using the tag information from the first tagging application; and
computer code for synchronizing the updated media playlist associated with the first client application with another media playlist that includes tagged media information from a second client application.

24. The computer readable medium of claim 23, further comprising computer code for forwarding media playlist information received from the media management server to the first tagging application.

25. The computer readable medium of claim 23, wherein the computer readable medium is firmware in a portable media device.

26. The computer readable medium of claim 23, wherein the computer readable medium is a hard drive in a computer.
